(19) United States
(12) Patent Application Publication
(10) Pub. No.: US 2023/0028782 A1
(43) Pub. Date: Jan. 26, 2023

(54) FIBER OPTIC PROCESSING SYSTEMS AND METHODS

(71) Applicant: COMMSCOPE TECHNOLOGIES LLC, Hickory, NC (US)

(72) Inventors: Mandy Lea TRNKA, Lonsdale, MN (US); Scott L. CARLSON, Bloomington, MN (US); Jaime GONZALEZ BATISTA, Prior Lake, MN (US); Richard S. TIEV, Shakopee, MN (US); Yu LU, Eden Prairie, MN (US)

(73) Assignee: COMMSCOPE TECHNOLOGIES LLC, Hickory, NC (US)

(21) Appl. No.: 17/788,673

(22) PCT Filed: Dec. 21, 2020
(86) PCT No.: PCT/US2020/066454

§ 371 Date: Jun. 23, 2022

Related U.S. Application Data
(60) Provisional application No. 62/952,897, filed on Dec. 23, 2019.
(60) Provisional application No. 62/952,877, filed on Dec. 23, 2019.

(51) Int. Cl. G02B 6/25; G02B 6/38; G02B 6/245

(52) U.S. Cl. CPC G02B 6/25; G02B 6/3861; G02B 6/245; G02B 6/3863

(57) ABSTRACT

Processing operations allow optical fibers to be efficiently installed in ferrules. An optical fiber holding device includes a clip having a length that extends between a first end and a second end. The clip includes a base and a cover that each extend between the first end and second ends. The clip includes a fiber passage that located between the cover and the base that extends between the first and second ends. The clip defines a ferrule boot receptacle at the first end.

### CROSS-REFERENCE TO RELATED APPLICATIONS

This application is being filed on Dec. 21, 2020 as a PCT International Patent Application and claims the benefit of U.S. Patent Application Ser. No. 62/952,897, filed on Dec. 23, 2019, and claims the benefit of U.S. Patent Application Ser. No. 62/952,877, filed on Dec. 23, 2019, the disclosures of which are incorporated herein by reference in their entireties.

### TECHNICAL FIELD

The present disclosure relates generally to methods and systems for processing components of fiber optic connectors. More particularly, the present disclosure relates to methods for processing optical fibers used in fiber optic connectors.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Fiber optic connectors are an important part of most fiber optic communication systems. Fiber optic connectors allow optical fibers to be quickly optically connected without requiring a splice. Fiber optic connectors can include single fiber connectors and multi-fiber connectors.

A typical fiber optic connector includes a ferrule assembly supported at a distal end of a connector housing. A spring is used to bias the ferrule assembly in a distal direction relative to the connector housing. The ferrule functions to support an end portion of at least one optical fiber (in the case of a multi-fiber ferrule, the ends of multiple fibers are supported). The ferrule has a distal end face at which a polished end of the optical fiber is located. When two fiber optic connectors are interconnected, the distal end faces of the ferrules abut one another and the ferrules are forced proximally relative to their respective connector housings against the bias of their respective springs. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. U.S. Pat. Nos. 5,883,995 and 6,142,676, which are hereby incorporated by reference in their entireties, disclose a ferrule-less fiber optic connector having an optical fiber having a ferrule-less end portion that is accessible at a front end of a connector body of the fiber optic connector. U.S. Pat. No. 6,957,920, which is hereby incorporated by reference in its entirety, discloses a multi-fiber ferrule having protruding optical fibers.

The manufacturing of optical connectors typically includes many steps and is quite cost and time intensive. WO 2017/087849 discloses methods and systems for simplifying the operations involved in processing fiber optic connectors. During the manufacture of fiber optic connectors, clips are used to hold optical fibers during processes such as stripping, cleaving and ferrule insertion. Example clips for holding optical fibers are disclosed by U.S. Pat. Nos. 5,524,167 and 8,485,735.

Alternative methods and systems for simplifying the operations involved in processing fiber optic connectors are also desirable.

### SUMMARY

Aspects of the present disclosure relate to devices, processes, stations, fiber holding clips and methods for enhancing the efficiency for manufacturing optical fiber and ferrule assemblies. An example optical fiber and ferrule assembly includes an optical fiber secured within a fiber passage of a ferrule. Example processing stations can include ferrule boot insertion stations, ferrule installation stations, optical fiber coating stripping stations, optical fiber cleaving stations and other stations. Example devices can include fiber holding clips capable of holding optical fibers in a row. Example processes in accordance with the principles of the present disclosure can involve pre-cleaving an optical fiber prior to inserting the ferrule over the optical fiber, and then positioning the pre-cleaved optical fiber relative to the ferrule such that the optical fiber projects a predetermined distance beyond an end face of the ferrule. In certain examples, positioning of the optical fiber relative to the ferrule can be achieved by establishing reference locations with respect to both the optical fiber and the ferrule, and then aligning the reference locations. In certain examples, the fiber reference location can be defined by a clip holding the optical fiber, and the ferrule reference location can be established by a fixture or station that holds the ferrule during the insertion process. In certain examples, the cleaved end of the optical fiber can be positioned in close proximity to a final desired position of the cleaved end relative to the end face of the ferrule. In this way, subsequent polishing steps typically used to shorten the optical fiber after cleaving can be reduced or eliminated thereby simplifying the manufacturing process. In certain examples, the cleaved end of the optical fiber can be positioned closer to the end face of the ferrule than can typically be achieved using existing post-cleave operations that cleave the optical fiber after insertion of the optical fiber through the ferrule. In certain examples, the ferrule itself can be pre-shaped or pre-formed to a desired geometry thereby reducing or eliminating the need for polishing of the ferrule itself to achieve a desired ferrule geometry. In certain examples, the fiber can be secured within the ferrule such that the cleaved end of the optical fiber is positioned within 15, 12, or 10 microns of the end face of the ferrule. In certain examples, processing stations such as ferrule boot insertion stations and ferrule insertions stations can be equipped with slidable ferrule or ferrule boot holders that facilitate the ferrule or ferrule boot insertion process.

Another aspect of the present disclosure relates to a boot installation station for inserting a ferrule boot over optical fibers intended to be connectorized. The boot installation system includes a clip nest and a boot nest. The clip nest is adapted for receiving a clip that holds the optical fibers, and the boot nest is adapted for receiving the ferrule boot. The boot nest is incorporated within a carrier that is linearly slidable relative to the clip nest. The clip is adapted to be positioned in the clip nest with free ends of the optical fibers extending toward the carrier. The carrier is linearly slidable relative to the clip nest between a retracted position and an extended position. The retracted position of the carrier is closer to the clip nest than the extended position of the carrier. In use, the ferrule boot is positioned in the boot nest of the carrier while the carrier is in the extended position. The carrier is then slid linearly toward the clip nest from the extended position to the retracted position to cause the free ends of the optical fibers to be inserted through the ferrule boot causing the ferrule boot to be installed over the optical fibers.

Another aspect of the present disclosure relates to a ferrule installation station for installing a multi-ferrule onto a plurality of optical fibers. The ferrule installation station includes a clip nest adapted for receiving a clip for holding the plurality of optical fibers, and a ferrule nest adapted for receiving the multi-fiber ferrule. The ferrule nest is integrated in a carrier that is linearly slidable relative to the clip nest between an extended position and a retracted position. The retracted position of the carrier is closer to the clip nest than the extended position of the carrier. The ferrule installation station is used by positioning the carrier in the extended position and positioning the ferrule in the ferrule nest and the clip in the clip nest with the optical fibers extending from the clip nest toward the carrier. The carrier is then moved from the extended position to the retracted position such that the optical fibers held by the clip are received within corresponding fiber passages defined by the ferrule. In certain examples, the ferrule installation station can include a stop that snaps to a stop position when the carrier reaches the retracted position to retain the carrier in the retracted position. In certain examples, the stop can be depressed to allow the carrier to be returned from the retracted position to the extended position. In certain examples, the ferrule installation station can include a ferrule ejection lever for ejecting the ferrule from the ferrule nest. In certain examples, the ferrule ejection lever can be pivotally connected to the carrier. In certain examples, a spring mechanism can bias the carrier toward the retracted position. In certain examples, the carrier is movable linearly toward and away from the clip nest for allowing adhesive to be worked through fiber passages of the ferrule after insertion of the ferrule over the fibers.

A further aspect of the present disclosure relates to a method for operating an optical fiber processing machine (e.g., an optical fiber cleaving machine, an optical fiber stripping machine or other fiber processing machine) in which a processing length of the machine can be altered. In certain examples, the method can include installing a selected one of a plurality of different clip-nest defining inserts within the machine to establish one of a plurality of different a mounting positions of a fiber holding clip relative to an active location of the machine. Examples of active locations can include fiber cleaving locations for fiber cleaving machines and strip initiation locations for fiber stripping machines. By using the nest-defining inserts, the spacing between the action performed on the optical fiber by the machine and a reference location on the fiber holding clip can be customized. In this way, lengths such as fiber strip lengths and fiber cleave lengths can be customized.

Another aspect of the present disclosure relates to a fiber optic holding clip for holding a plurality of optical fibers. The fiber optic holding clip can be used to hold optical fibers as the optical fibers are moved to different processing stations of a connector manufacturing process. In certain examples, the fiber holding clip can be adapted to be received within clip receivers (e.g., nests) of any number of different fiber processing stations such as optical fiber stripping stations, optical fiber cleaving stations, ferrule boot insertion stations and ferrule insertion stations.

In one example, the fiber holding clip includes a base and a cover. The cover can be pivotally movable relative to the base between an open position and a closed position. A latch can be provided for retaining the cover in the closed position. A fiber positioning member can be attached to the cover. When the cover is moved to the closed position, the fiber positioning member can nest within a receptacle defined by the base. The positioning member and the cover can cooperate to form a fiber alignment portion which defines a fiber alignment slot for receiving optical fibers. Preferably, the optical fibers are arranged within a row within the slot with end portions projecting outwardly from a front end of the clip. In certain examples, the slot is configured to receive at least twelve optical fibers in a single row. Adjacent the front end of the clip, the cover and the base cooperate to define a boot receptacle adapted for receiving the rear end of a multi-fiber ferrule boot. During processing, the multi-fiber ferrule boot can be inserted over the end portions of the optical fibers while the optical fibers are held in a row by the fiber holding clip. For example, the ferrule boot can be slid rearwardly on the end portions of the optical fibers until a rear end of the ferrule boot is received within the boot receptacle (e.g., a boot pocket) defined between the cover and the base of the clip. A multi-fiber ferrule can later be inserted over the optical fiber and ferrule boot held by the clip. Alternatively, the ferrule boot can be pre-loaded in the multi-fiber ferrule, and the multi-fiber ferrule and the ferrule boot can be inserted together over the optical fibers.

A variety of additional aspects will be set forth in the description that follows. The aspects relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a flow chart outlining a process in accordance with the principles of the present disclosure;

FIG. 2 is a top view of an example fiber holding clip suitable for use in practicing the process of FIG. 1;

FIG. 3 is a bottom view of the fiber holding clip of FIG. 2;

FIG. 4 schematically depicts a ferrule boot installation station suitable for use in practicing the process of FIG. 1;

FIG. 5 is another view of the ferrule boot installation station of FIG. 4, the ferrule boot installation station is shown in an extended position with a ferrule boot loaded into a carrier of the ferrule boot installation station and the fiber holding clip of FIGS. 2 and 3 loaded into a clip nest of the ferrule boot installation station;

FIG. 6 shows the ferrule boot installation station of FIG. 5 in a retracted position;

FIG. 7 schematically depicts a fiber coating stripping station suitable for use in practicing the process of FIG. 1, the fiber coating stripping station has inserts that can be interchangeably installed in a nest of the stripping station to provide different strip lengths;

FIG. 8 depicts the fiber coating stripping station of FIG. 7 in a retracted position;

FIG. 9 depicts the fiber coating stripping station of FIG. 7 in an extended position;

FIG. 10 schematically depicts an example mechanical cleaving station suitable for use in practicing the process of FIG. 1, the cleaving station has inserts that can be interchangeably installed in a nest of the cleaving station to provide different cleave lengths;

FIGS. 11A-11D schematically depict sequential operational views of the mechanical cleaving station of FIG. 10;

FIG. 12 schematically depicts an example ferrule installation station suitable for use in practicing the process of FIG. 1;

FIG. 13 is a perspective view of the ferrule installation station of FIG. 12;

FIG. 14 depicts the ferrule installation station of FIG. 13 in an extended position with a ferrule loaded into a carrier of the ferrule installation station and the fiber holding clip of FIGS. 1 and 2 loaded into a nest of the ferrule installation station;

FIG. 15 depicts the ferrule installation station of FIG. 14 in a retracted position in which the ferrule has been inserted over optical fibers held by the fiber holding clip;

FIG. 16 depicts an example station mounting configuration in which a boot installation station and a ferrule installation station in accordance with the principles of the present disclosure are mounted on the same plate;

FIG. 17 is an exploded view of a multi-fiber optical connector including a multi-fiber ferrule that is one example of the type of optical fiber ferrule that can be processed utilizing processes in accordance with the principles of the present disclosure;

FIG. 18 is a cross-sectional view of the multi-fiber optical connector of FIG. 17.

FIG. 19 shows a fiber holding clip in accordance with the principles of the present disclosure, the fiber holding clip is shown in an open position with the plurality of optical fibers aligned in a row within a fiber alignment portion of the fiber holding clip;

FIG. 20 shows the fiber holding clip of FIG. 19 with a ferrule boot inserted over the optical fibers and the fiber holding clip in a closed position;

FIG. 21 shows the fiber holding clip of FIG. 20 in an open position to expose the interior of the fiber holding clip and to show how the ferrule boot fits within the fiber holding clip;

FIG. 22 shows the fiber holding clip of FIG. 21 with a ferrule inserted over the optical fibers and ferrule boot held by the fiber holding clip;

FIG. 23 is an exploded view depicting a multi-fiber connector (e.g., an MPO connector) having a multi-fiber ferrule with a ferrule boot adapted to be mounted at a rear end of the multi-fiber ferrule; and

FIG. 24 is a cross-sectional view showing the multi-fiber connector of FIG. 23 assembled.

### DETAILED DESCRIPTION

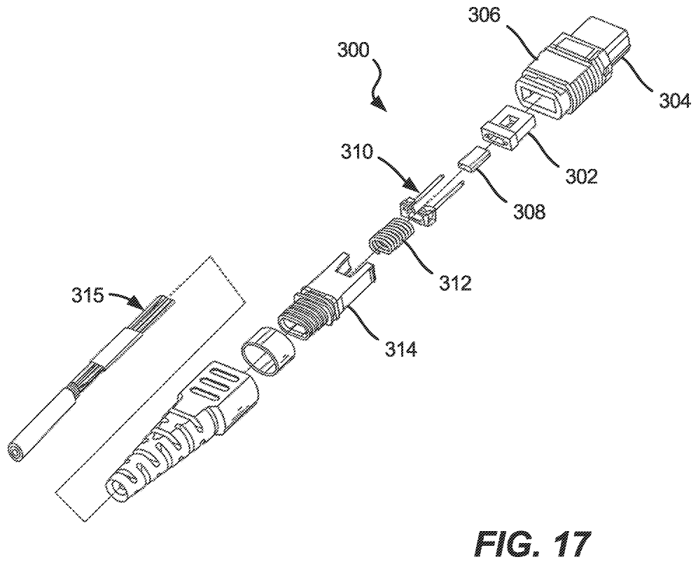

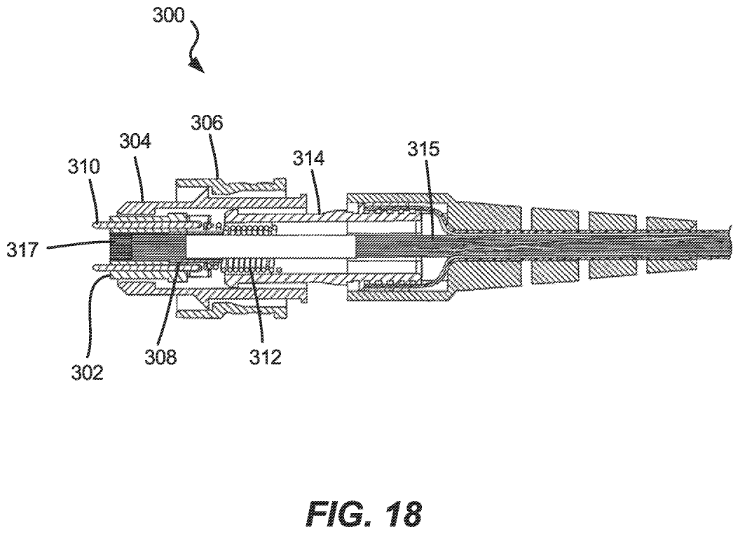

FIGS. 17 and 18 depict an example multi-fiber optical connector 300 (e.g., an MPO connector) having a ferrule assembly that is one example of a type of ferrule assembly that can be processed in accordance with aspects of the present disclosure. The optical connector 300 includes a multi-fiber ferrule 302 (e.g., an MPO ferrule) that mounts within a connector body 304. A release sleeve 306 for disengaging the connector body 304 from a fiber optic adapter is retractably mounted on the connector body 304. A ferrule assembly mounts within the connector body 304. The ferrule assembly includes the ferrule 302, a ferrule boot 308, an alignment pin assembly 310 and a spring 312. The ferrule assembly is retained within the connector body 304 by a rear connector body 314. When assembled, the spring 312 biases the ferrule 302 in a forward direction relative to the connector body 304.

FIG. 18 depicts the fiber optic connector 300 of FIG. 17 in an assembled configuration. As depicted at FIG. 18, optical fibers 315 extend through the ferrule boot 308 and through openings defined by the ferrule 302. The ferrule boot 308 is mounted within a rear portion of the ferrule 302. In certain examples, the ferrule boot 308 assists in containing epoxy within the ferrule 302. It will be appreciated that the epoxy can be injected or otherwise provided within the ferrule 302 for securing the optical fibers 315 within the ferrule 302.

In certain examples, the ferrule 302 can be constructed of a material such as a plastic, a metal or a ceramic. A common ceramic material used in the manufacture of ferrules includes zirconia. A common plastic material used for multi-fiber ferrules includes polyphenylene sulfide (PPS) and preferably includes glass filled PPS. The optical fibers can include single mode optical fibers or multi-mode optical fibers.

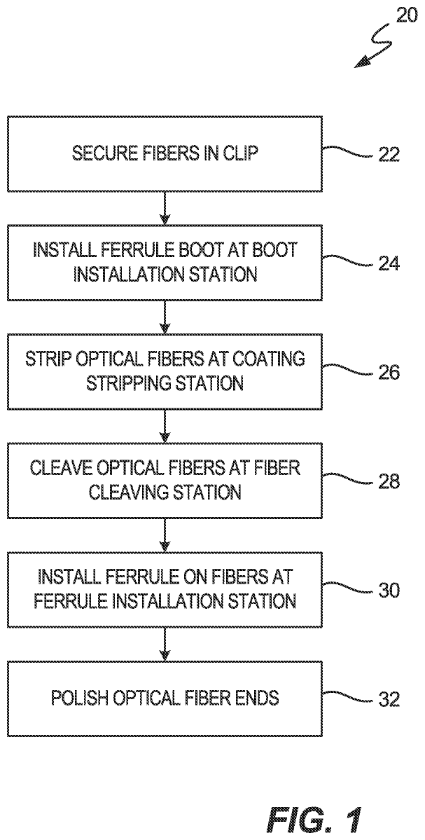

FIG. 1 depicts an example process 20 in accordance with the principles of the present disclosure. The process starts with step 22 in which optical fibers are secured in a fiber holding clip. The process 20 then proceeds to step 24 where a ferrule boot is installed over the optical fibers at a boot installation station. The process then proceeds to step 26, at which the optical fibers are stripped at a fiber coating stripping station. Thereafter, at step 28, the optical fibers are cleaved at a fiber cleaving station. Next, at step 30, a ferrule is installed on the fibers at a ferrule installation station. As part of the installation process, the optical fibers can be bonded within the ferrule by an adhesive material such as epoxy. Thereafter, at step 32, ends of the optical fibers as well as the end of the ferrule can be further processed by techniques such as polishing.

The process 20 of FIG. 1 is directed toward a process for manufacturing an optical fiber and ferrule assembly. In certain examples, the optical fiber and ferrule assembly can include a row of optical fibers secured within parallel fiber passages of a ferrule (e.g., see optical fibers 315 within passages of the ferrule 302 of the optical connector 300 of FIGS. 17 and 18). As shown at FIG. 18, the fiber passages extend in a rear-to-front orientation through the ferrule 302. The fiber passages each have a front end at a front face 317 of the ferrule 302.

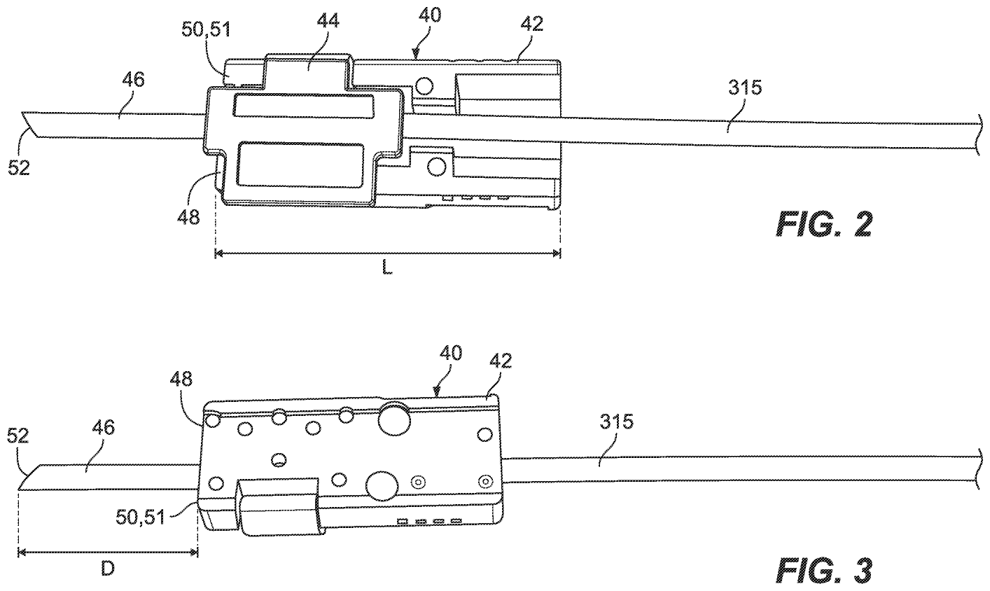

Referring back to FIG. 1, the process 20 starts by securing optical fibers in a fiber holding clip. For example, FIGS. 2 and 3 show the optical fibers 315 secured in a row within a fiber holding clip 40. The clip 40 includes a base 42 and a fiber retention cover 44. The fiber retention cover 44 is movable relative to the base 42 between an open position and a closed position (shown in FIGS. 2 and 3). When the cover 44 is in the open position (not shown), the optical fibers 315 can be placed within a channel defined through a length L of the base 42. The fiber retention cover 44 can then be moved to the closed position (shown at FIGS. 2 and 3) in which the optical fibers 315 are clamped relative to the base 42. When clamped, front end portions 46 of the optical fibers 315 project forwardly beyond a front end 48 of the base 42. In certain examples, a fiber reference location 50 can be established relative to the optical fibers 315 on the clip 40. For example, a front edge 51 of the clip 40 can be used as the fiber reference location 50 with respect to ends 52 of the optical fibers 315. The front end portions 46 of the optical fibers 315 extend a distance D beyond the fiber reference location 50.

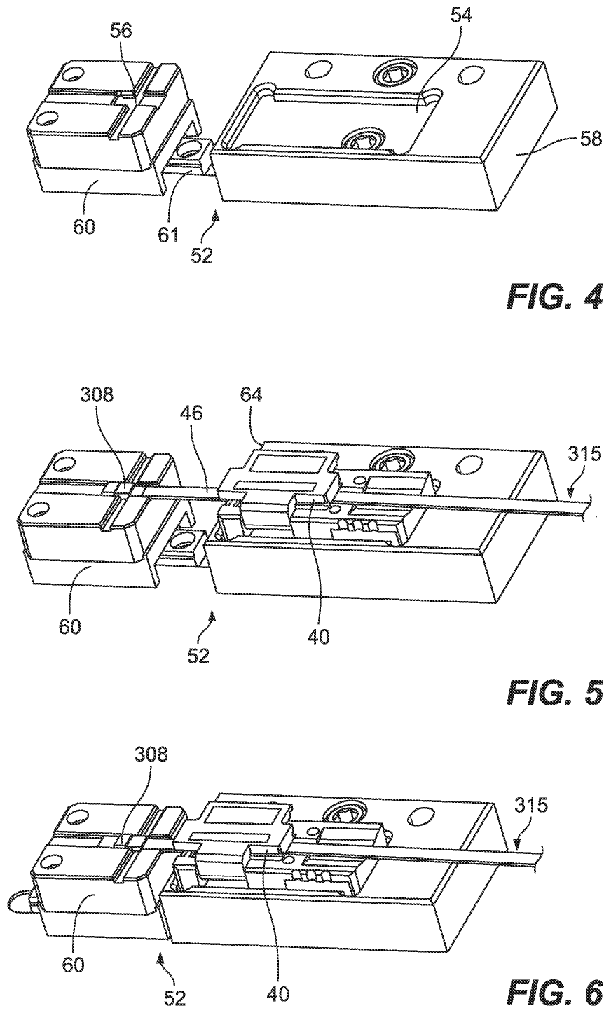

Once the optical fibers 315 have been secured within the fiber holding clip 40, the ferrule boot 308 can be inserted over the front end portions 46 of the optical fibers 315 at a boot installation station. FIGS. 4-6 depict an example ferrule boot installation station 52 in accordance with the principles of the present disclosure. The ferrule boot installation station 52 includes a clip nest 54 and a boot nest 56. The ferrule boot installation station 52 includes a platform 58 defining the clip nest 54 and a carrier 60 defining the boot nest 56. The carrier 60 is movable relative to the clip nest 54 between an extended position (see FIGS. 4 and 5) and a retracted position (see FIG. 6). The carrier 60 mounts on a linear guide 61 (e.g., a linear guide rail) that guides linear movement of the boot nest 56 between the extended and retracted positions. The boot nest 56 is configured to receive the ferrule boot 308 of the optical connector 300. When the ferrule boot 308 is mounted within the boot nest 56, a through passage of the boot nest 56 is aligned parallel to the direction of linear movement of the carrier 60 as the carrier moves along the linear guide 62. An open passage of the ferrule boot 308 preferably faces toward the clip nest 54.

The clip nest 54 is configured to receive the fiber holding clip 40 such that the optical fibers 315 held by the clip 40 are coaxially aligned with the through-passage of the ferrule boot 308 which is mounted within the boot nest 56. When the clip 40 is mounted within the clip nest 54, the front end portions 46 of the optical fibers 315 preferably extend toward the carrier 60 and overhang an edge 64 of the platform 58. To install the ferrule boot 308 over the front end portions 46 of the optical fibers 315, the ferrule boot installation station 52 is moved to the extended orientation as shown at FIG. 4, and then the ferrule boot 308 is loaded into the boot nest 56 and the fiber holding clip 40 is loaded into the clip nest 54 as shown at FIG. 5. The carrier 60 is then moved toward the platform 58 from the extended position of FIG. 5 to the retracted position of FIG. 6. As the carrier 60 is moved from the extended position to the retracted position, the end portions 46 of the optical fibers 315 are received within the through passage of ferrule boot 308 such that the ferrule boot 308 is effectively inserted over the end portions 46 of the optical fibers 315. In this way, the ferrule boot 308 is installed on the optical fibers 315 held by the fiber holding clip 40.

Once the ferrule boot 308 has been installed on the optical fibers 315 at the ferrule boot installation station 52, the fiber holding clip 40 is removed from the clip nest 54 thereby concurrently moving the ferrule boot 308 from the boot nest 56 as the ferrule boot 308 is carried with the optical fibers 315 held by the clip 40. In certain examples, the ferrule boot 308 can be manually slid further on the fibers 315 after removal of the clip 40 from the ferrule boot installation station 52.

The clip is next moved a coating stripping station where a fiber coating layer (e.g., an acrylate coating layer) is stripped from the end portions 46 of the optical fibers 315. It will be appreciated that the optical fibers typically include a core, a cladding layer surrounding the core, and a coating layer surrounding the cladding layer. It is desirable for the coating layer to be removed from the cladding layer prior to inserting the optical fibers into the ferrule 302. Thus, it is preferred for the portions of the optical fibers received within the passages of the ferrule 302 to be bare (e.g., to include only a core surrounded by a cladding layer).

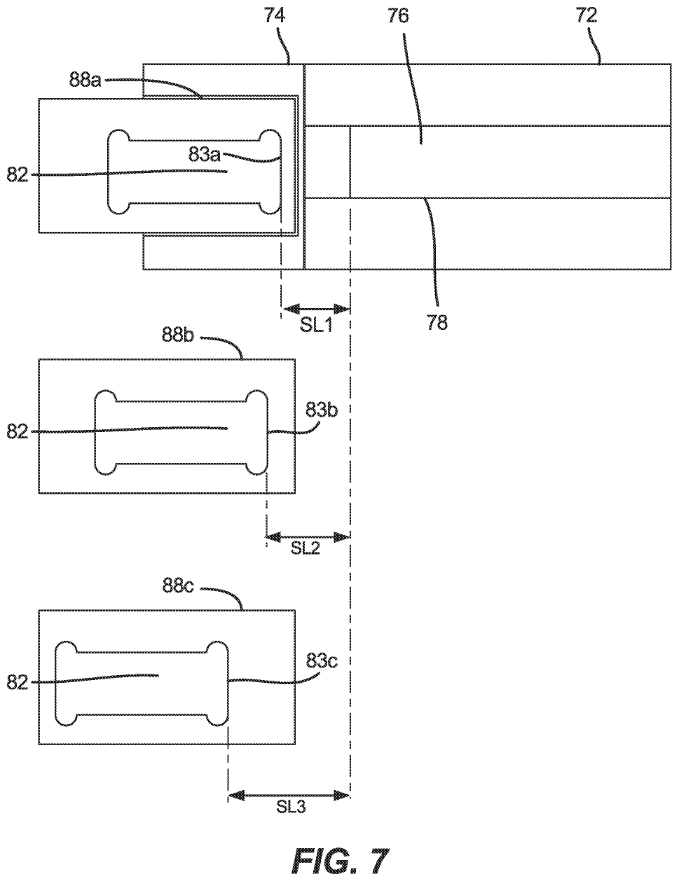

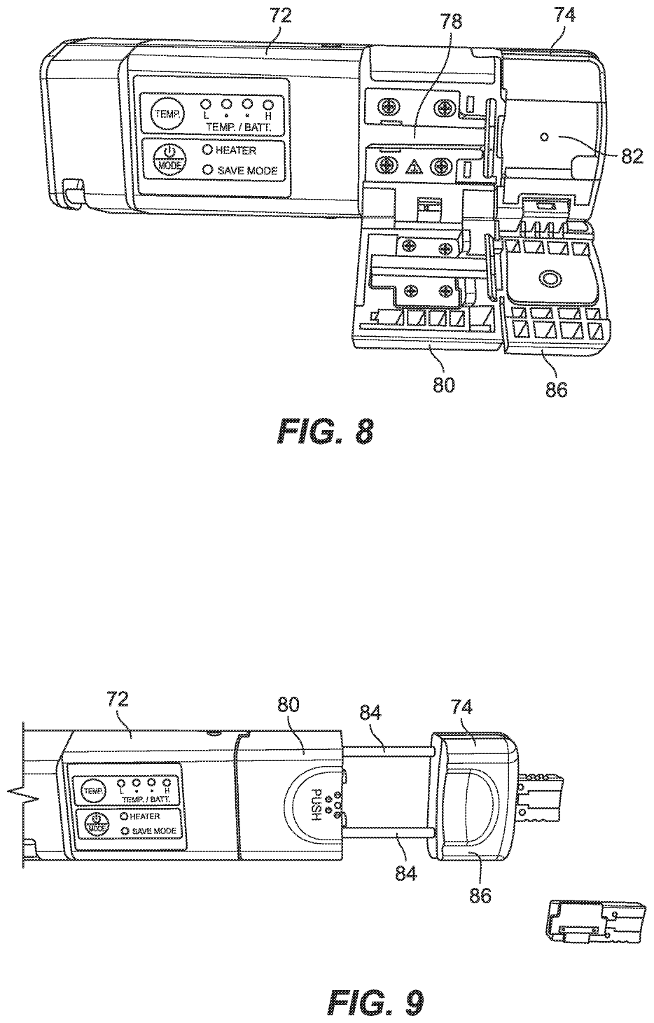

FIGS. 7-9 depict an example hot jacket stripper 70 suitable for stripping coating layers from optical fibers. The hot jacket stripper 70 includes a main control unit 72 and a carrier 74. The main control unit 72 includes a heated stripping region 76 defining a channel 78 for receiving the end portions 46 of the optical fibers 315. The heated stripping region 76 also includes a cover 80 that is closed to clamp coated optical fibers against a heated surface which defines the channel 78 of the heated stripping region 76. The carrier 74 defines a clip nest 82 for receiving the fiber holding clip 40. The carrier 74 is movable relative to the heated stripping region 76 between a retracted position (see FIG. 8) and an extended position (see FIG. 9). Linear guides 84 guide linear movement of the carrier 74 between the extended and retracted positions. The carrier 74 also includes a cover 86 for clamping the fiber holding clip 40 within the clip nest 82.

In certain examples, the hot jacket stripper 70 can include a plurality of inserts 88a, 88b and 88c that can be interchangeably installed in the carrier 74 to provide different strip lengths. Each of the inserts 88a-88c can define a clip nest 82 configured for receiving the fiber holding clip 40. The clip nest 82 defines a reference location 83 (e.g., an edge) that coincides with the reference location 50 of the clip 40 when the clip 40 is mounted in the clip nest 82. When one of the inserts 88a-88c is mounted within the carrier 80, the selected insert 88a-88c defines the clip nest 82 of the carrier 74. The inserts 88a-88c define their respective clip nests 82 and corresponding reference locations 83a-83c at different relative locations within the main bodies of the inserts 88a-88c so as to provide different strip lengths. Thus, when the clip 40 is mounted in clip nests 82 the different inserts 88a-88c, the different positioning of the clip nests 82 and their corresponding reference locations 83a-83c causes the positioning of the reference location 50 of the clip 40 to be varied relative to the main bodies of the inserts 88a-88c. It will be appreciated that the inserts 88a-88c allow the fibers 315 to be stripped starting at different strip initiation distances with respect to the fiber reference location 50 defined by the fiber holding clip 50. For example, when the insert 88a is used during stripping, a length SL1 is defined between the front edge 50 of the clip 40 and a strip initiation location 90 at which stripping of the fiber coating is initiated. If insert 88b is used during stripping, a length SL2 is provided between the front edge 50 and the strip initiation location 90. Similarly, if insert 88c is used during stripping, a length SL3 is defined between the front edge 50 and the initiation location. Length SL2 is longer than length SL1 and length SL3 is longer than length SL2.

In use of the hot jacket stripper 70, the carrier 74 is moved to the retracted position of FIGS. 7 and 8 and the covers 80, 86 are open. The fiber holding clip 40 is then mounted within the clip nest 82 of the carrier 74 such that the end portions 46 of the optical fibers 315 extend past the strip initiation location 90 along the channel 78 of the heated stripping region 76. It will be appreciated that the clip nest 82 can be defined by the nest of the desired insert 88a-88c installed within the carrier 74. Thereafter, the covers 80, 86 are closed and the heated stripping region 76 is heated to heat the coating layer covering the end portions 46 of the optical fibers 315 that extend past the strip initiation location 90. Subsequently, with the cover 80 compressed against the fibers within the heated stripping region 76 and the cover 86 compressed against the clip 40 within the carrier 74, the carrier 74 is moved to the extended position as shown at FIG. 9 causing the heated portion of the coating covering the optical fibers 315 to be stripped from the underlying bare optical fibers. After the carrier 74 has been moved to the extended position, the covers 80, 86 can be open and the clip 40 can be removed and moved to the next station.

It will be appreciated that each of the inserts 88a-88-c defines a corresponding reference location 83a-83c (e.g., a front edge of each nest) that contacts or coincides with the reference location 50 (e.g., the front edge of the clip 40) when the clip 40 is mounted within the corresponding nests. Therefore, by varying the relative positions of the nests 82, and therefore the corresponding reference locations 83a-83c, the strip length provided by the hot jacket stripper 70 can be varied based on which insert 88a-88c is installed within the carrier 74.

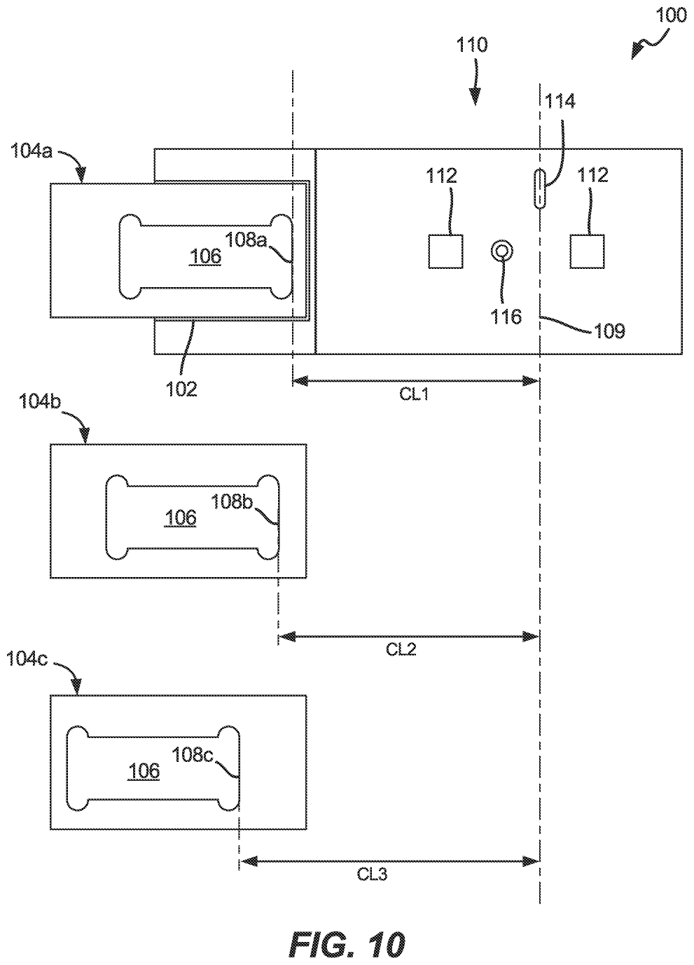

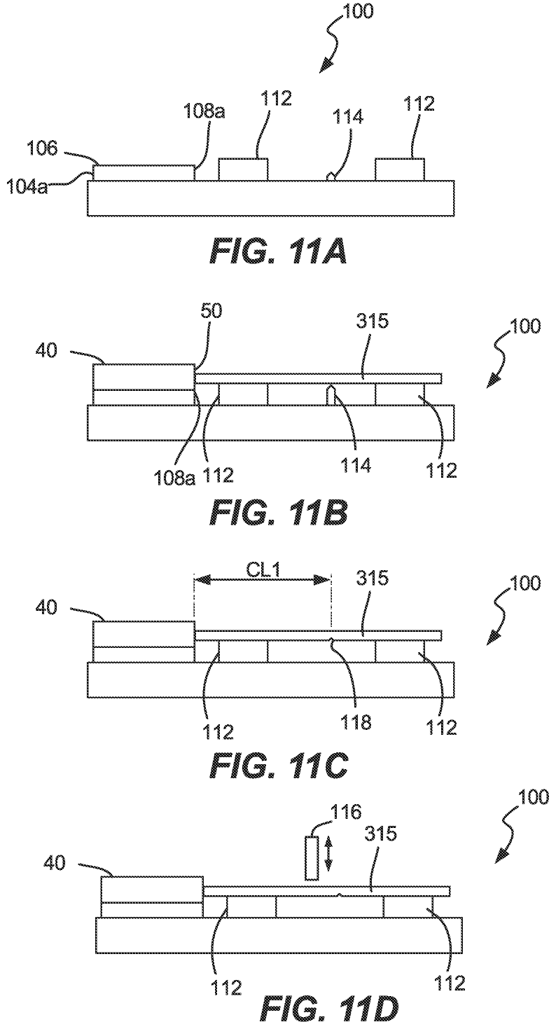

After the optical fibers 315 have been stripped at the hot jacket stripper 70, the fiber holding clip 40 which holds the stripped optical fibers 315 is transferred to a cleaving station for cleaving of the optical fibers. FIG. 10 and FIGS. 11a-11d depict an example fiber cleaving station 100 suitable for use in cleaving the optical fibers 315 held by the fiber holding clip 40. The fiber cleaving station 100 includes a pocket 102 in which one of a plurality of inserts 104a-104c can be interchangeably mounted. The inserts 104a-104c each define a clip nest 106 sized for receiving the fiber holding clip 40. The clip nests 106 of the inserts 104a-104c define different reference locations 108a-108c. When the fiber holding clip 40 is mounted within the clip nest 106 of one of the inserts 104a-104c, its reference location 50 contacts (e.g., generally coincides with) a corresponding one of the reference locations 108a-108c. It will be appreciated that the different reference locations 108a-108c correspond to different cleave lengths for the optical fibers 315. For example, when the insert 104a is mounted within the pocket 100 and used during cleaving, a cleave length CL1 is defined between the reference location 108a and a cleave position 109 of the fiber cleaving station 100. When the insert 104b is installed in the pocket 102 and used during cleaving, a cleave length CL2 is defined between reference location 102b and the cleave position 109. It will be appreciated that the cleave length CL2 is longer than the cleave length CL1. When the insert 104c is mounted in the pocket 102 and used during cleaving, a cleave length CL3 is defined between reference location 108c and the cleave position 109. It will be appreciated that the cleave length CL3 is longer than the cleave length CL2. Therefore, by selecting the appropriate insert 104a-104c, the desired cleave length can be implemented by the fiber cleaving station 100.

Referring to FIG. 10, the fiber cleaving station 110 includes a cleaving arrangement 110 positioned adjacent to the clip nest 106. The cleaving arrangement includes first and second pads 112, a scoring tool 114 and a tensioner 116. FIGS. 11a-11d depict a sequence of steps for cleaving the optical fibers 115 using the fiber cleaving station 110. FIG. 11a shows the cleaving station 100 with the insert 104a defining the clip nest 106 and also defining reference location 108a. FIG. 11b shows the fiber holding clip 40 mounted in the clip nest 106 with reference location 50 positioned at reference location 108a and with the stripped optical fibers 315 extending across the pads 112. With the optical fibers 315 extending across the pads 112, the scoring tool is used to generate a score mark 118 (see FIG. 11c) in the optical fibers 315. It will be appreciated that the score mark corresponds with a desired cleave location and is spaced a distance CL1 from the reference locations 50, 108a. Once the optical fibers 315 have been scored, the tensioner 116 applies pressure to the optical fibers 315 causing the optical fibers to flex between the pads 112 such that the fibers break at the score location 118 thereby providing a mechanical cleave. Once the mechanical cleave has been provided, the fiber holding clip 40 with the cleaved optical fibers held therein can be removed from the fiber cleaving station 100 and transferred to a ferrule installation station for insulation of the ferrule 302 on the cleaved optical fibers 315.

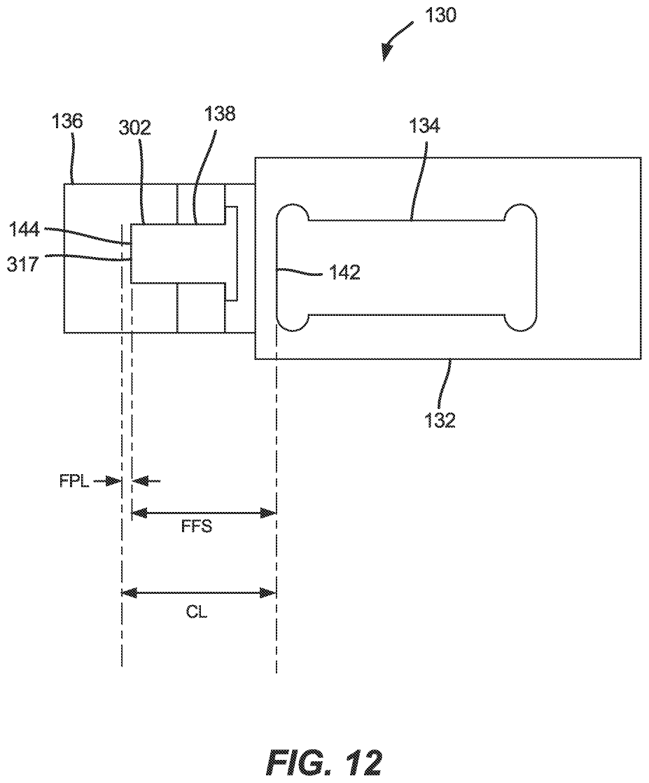

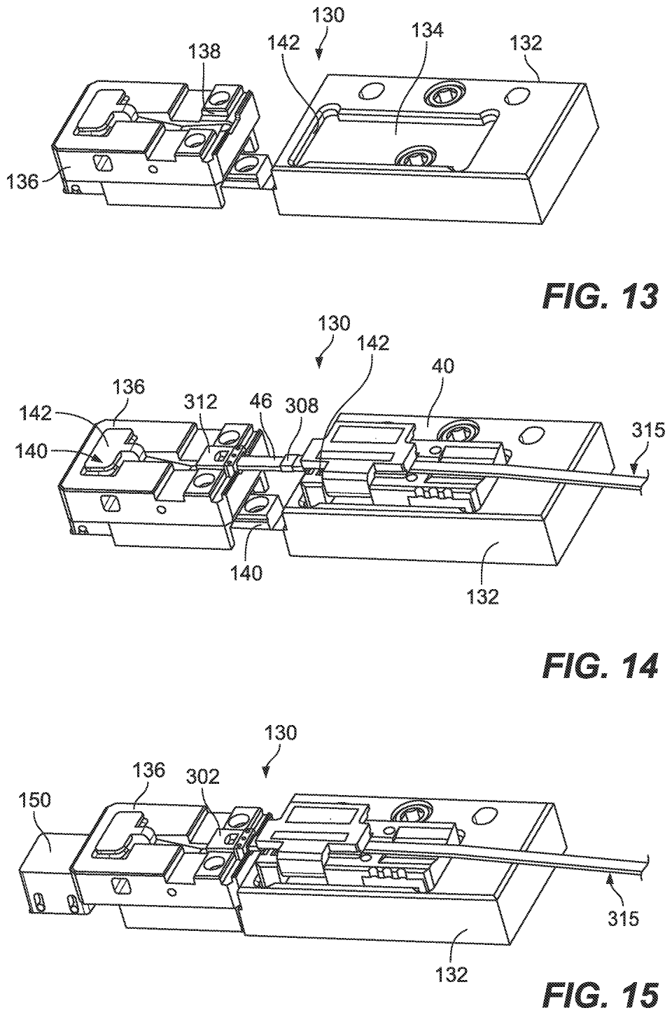

FIGS. 12-15 depict an example ferrule installation station 130 for installing the ferrule 302 on the pre-cleaved optical fibers 315. The ferrule installation station 130 includes a platform 132 defining a clip nest 134. The ferrule installation station 130 also includes a carrier 136 in which a ferrule nest 138 is incorporated. The clip nest 134 is adapted for receiving the fiber holding clip 40 and the ferrule nest 138 is adapted for receiving the ferrule 302. The carrier 136 is movable relative to the platform 132 between an extended position (FIGS. 13 and 14) and a retracted position (see FIGS. 12 and 15). A linear guide 140 is provided for guiding movement of the carrier 136 linearly between the extended and retracted positions. The clip nest 134 defines a reference location 142 that coincides with the reference location 50 defined by the fiber holding clip 40 when the fiber holding clip 40 is mounted within the clip nest 134. The ferrule nest 134 defines a ferrule face location 144 that coincides with the location of the front face 317 of the ferrule 302 when the ferrule 302 is mounted within the ferrule nest 138. When the carrier 136 is in the retracted position, the ferrule face location 144 is positioned a spacing FFS from the reference location 142 of the clip nest 134. The spacing FFS is preferably equal to the cleave length CL minus a fiber projection length FPL. The fiber projection length FPL is equal to the desired distance for the optical fibers 315 to project forwardly beyond the front face 317 of the ferrule 302 upon installation of the ferrule 302 on the optical fibers 315.

To use the ferrule installation station 130 to install the ferrule 302 on the optical fibers 315, the ferrule installation station 130 is initially moved to the extended position as shown at FIG. 13. With the fiber installation station 130 in the extended position as shown at FIG. 13, the ferrule 302 is loaded into the ferrule nest 134 of the carrier 136 and the fiber holding clip 40 holding the cleaved optical fibers 315 is loaded into the clip nest 134. It will be appreciated that the clip nest 134 and the ferrule nest 138 are relatively positioned in linear alignment such that fiber openings of the ferrule 302 are co-axially aligned with the optical fibers 315 held by the fiber holding clip 40. As shown at FIG. 14, the end portions 46 of the optical fibers 315 project forwardly from the fiber holding clip 40 toward the ferrule 302 mounted on the carrier 136. The front end portion 46 overhang an edge of the platform 132. Additionally, the ferrule boot 308 is positioned on the front end portions 46 and also overhangs the edge of the platform 132. Via the relative positioning of the clip nest 134 and the ferrule nest 138, the optical fibers 315 are co-axially aligned with the fiber openings of the ferrule 302. Therefore, by moving the carrier 136 from the extended position linearly toward the retracted position, the front end portions 46 of the optical fibers 315 are received within the fiber openings of the ferrule 302 and the ferrule boot 308 is received within a rear opening of the ferrule 302. With the carrier 136 in the retracted position, the optical fibers 315 extend through the ferrule 302 and tip portions of the optical fibers 315 project the desired fiber projection length FPL beyond the front end face 317 of the ferrule 302. Before or after the carrier 136 is in the retracted position, an adhesive material such as epoxy can be injected or otherwise applied to the ferrule to bond the optical fibers 315 in place relative to the ferrule 302. After the adhesive has cured, the fiber holding clip 40, which holds the optical fibers 315 with the ferrule 302 installed thereon, can be removed from the ferrule installation station 130 and moved for subsequent processing stations such as cleaning stations, polishing stations or other stations.

It will be appreciated that the ferrule installation station 130 can include features to facilitate operation of the ferrule installation station 130. For example, a ferrule ejection lever 140 can be pivotally connected to the carrier 136. The ferrule ejection lever 140 can configured to eject the ferrule 302 from the ferrule nest 138 by pressing an enlarged button portion 142 of the lever 140. It will be appreciated that when the enlarged portion 142 is depressed downwardly, the opposite end of the ferrule ejection lever 140 positioned beneath the ferrule 302 lifts the ferrule 302 out of the ferrule nest 138.

In certain examples, the ferrule installation station 130 includes a stop member 150 that can be spring actuated. In certain examples, once the carrier 136 is moved from the extended position to the retracted position, the stop member 150 automatically pops upwardly to lock the carrier 136 in the retracted position. The stop member 150 can retain the carrier 136 in the retracted position until after the ferrule 302 has been adhesively secured to the optical fibers 315. Thereafter, the stop button 150 can be manually depressed thereby allowing the carrier 136 to be slid back to the extended position.

In still other examples, the ferrule installation station 130 can include a spring or other structure for biasing the carrier 136 toward the platform 132. In certain examples, the spring or other structure can be used to hold the carrier 136 in the retracted position during application of the adhesive for securing the optical fibers 315 in the ferrule 302. In certain examples, the carrier 136 can be moved slightly back and forth along the linear guide 140 to facilitate moving adhesive within the ferrule 302 prior to curing the adhesive. A stop or other structure can be used to retain the carrier 136 in the extended position for such examples.

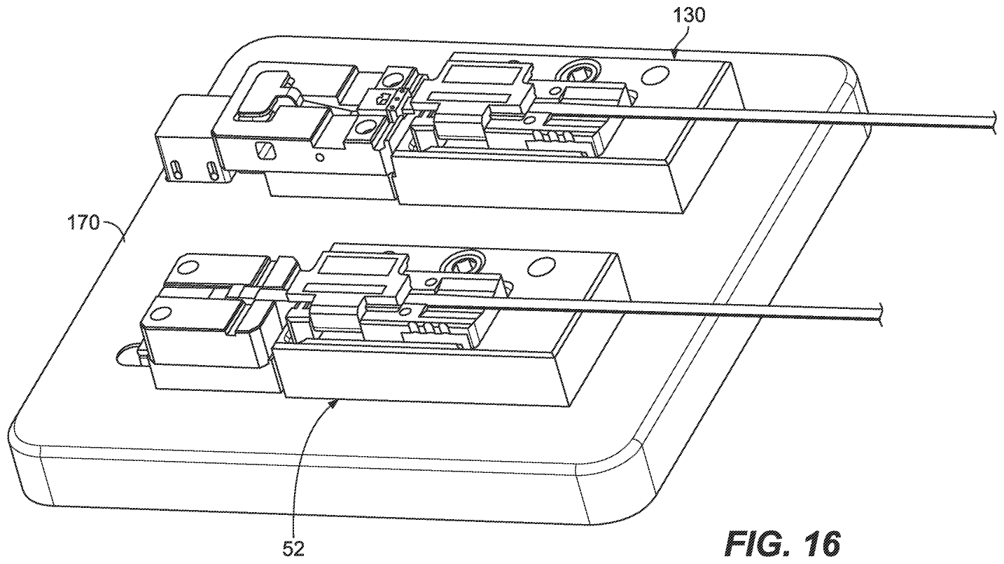

FIG. 16 shows an example mounting configuration for the ferrule boot installation station 52 and the ferrule installation station 130. In the depicted example, the ferrule installation station 130 and the ferrule boot installation station 152 are mounted on one plate 170.

It will be appreciated that the optical fiber can be cleaved by a mechanical cleaving process or a laser cleaving process. Example mechanical cleaving processes typically score the optical fibers at the desired cleave location, and then either flex or axially tension the optical fibers to cause the optical fibers to break at the scored location. In certain examples, the cleaved ends of the optical fibers as well as the front face of the ferrule can be further processed after the optical fibers have been secured within the ferrule. For example, the end face of the ferrule and the ends of the optical fibers can be subject to one or more subsequent polishing operations. However, by pre-cleaving the optical fibers and then positioning the cleaved ends in front of the end face of the ferrule, the cleaved ends can be positioned in relatively close proximity to the front face of the ferrule. For example, the cleaved end can be positioned within 20 microns, or 15 microns, or 12 microns, or 10 microns, of 5 microns of the front end face of the ferrule. Therefore, because the protrusion length of the optical fiber is relatively small, in certain examples, a reduced number of polishing steps may be utilized thereby reducing cost as compared to conventional processes for manufacturing optical fiber end ferrule assemblies. In certain examples, the ferrule itself can be pre-manufactured with a desired geometry or shape (e.g., molded to a desired shape) thereby further reducing the amount of processing required of the optical fiber and ferrule assembly after securement of the optical fibers within the ferrule.

Other aspects of the present disclosure relate to fiber folding devices such as fiber holding clips adapted for holding one or more optical fibers. In a preferred example, the present disclosure relates to fiber optic clips adapted to hold a plurality of optical fibers in a row. In certain examples, the fiber optic holding clip can hold the optical fibers in the row as the optical fibers are moved to different processing stations of a connector manufacturing process. In certain examples, the fiber holding clip can be adapted to be received within clip receivers (e.g., nests) in any number of different fiber processing stations such as optical fiber stripping stations, optical fiber cleaving stations, ferrule boot insertion stations and ferrule insertion stations. In other examples, the fiber holding clip can be configured to be mounted within an adapter that fits within any number of different fiber processing stations such as optical fiber stripping stations, optical fiber cleaving stations, ferrule boot insertion stations and ferrule insertion stations.

In certain examples, the fiber holding clips in accordance with the principles of the present disclosure can hold a plurality of optical fibers in a row with end portions of the optical fibers projecting forwardly beyond an end of the fiber holding clip. It will be appreciated that the end portions can be presented for processing at any number of different fiber processing stations as the optical fibers remain held by the fiber holding clip. For example, coatings of the optical fibers can be stripped from the end portions of the optical fibers at an optical fiber stripping station while the fiber holding clip holds the optical fibers. Similarly, the end portions of the optical fibers can be cleaved at an optical fiber cleaving station while the optical fibers remain held by the fiber holding clip. Further, after stripping and cleaving, a ferrule boot can be inserted over the end portions of the optical fibers at a ferrule boot insertion station while the optical fibers remain held in a row by the fiber holding clip. Further, after the ferrule boot has been inserted over the end portions of the optical fibers at the ferrule boot insertion station, a ferrule can be inserted over the end portions of the optical fiber and over the ferrule boot at a ferrule insertion station while the fiber holding clip holds the optical fibers and positions the ferrule boot. At the ferrule insertion station, adhesive may be used to secure the optical fibers within the ferrule. Subsequently, the fiber holding clip may also be used to hold the optical fibers during subsequent processing such as polishing of the end face of the ferrule and optical fibers. In other examples, the boot can be inserted installed on the optical fiber prior to stripping and/or cleaving of the optical fibers.

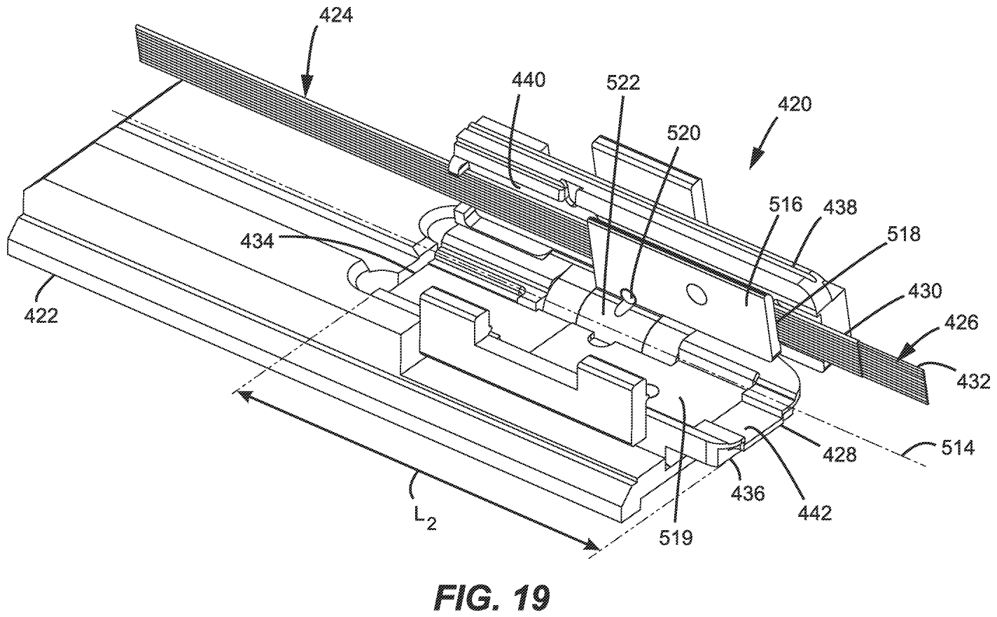

FIGS. 19-22 depict an example fiber holding clip 420 in accordance with the principles of the present disclosure. The fiber holding clip 420 is shown mounted within an adapter 422 adapted to be mounted within any number of different fiber processing stations such as optical fiber stripping stations, optical fiber cleaving stations, ferrule boot insertion stations and ferrule insertion stations. The fiber holding clip 420 is depicted holding a plurality of optical fibers 424 in a single row. In a preferred example, the fiber holding clip 420 is adapted to hold at least twelve of the optical fibers 424 in a single row. In the depicted example, the optical fibers 424 are shown including end portions 426 that project forwardly beyond a front end 428 of the fiber holding clip 420. The optical fibers 424 include coating layers 430. At the end portions 426 of the optical fibers 424, the coating layers 430 have been stripped to expose bare fiber portions 432 of the optical fibers. It will be appreciated that the bare fiber portions 432 can include a glass core surrounded by a cladding layer that has been exposed through stripping of the coating layer 430. In certain examples, the coating layer can be made of a polymeric material such as acrylate.

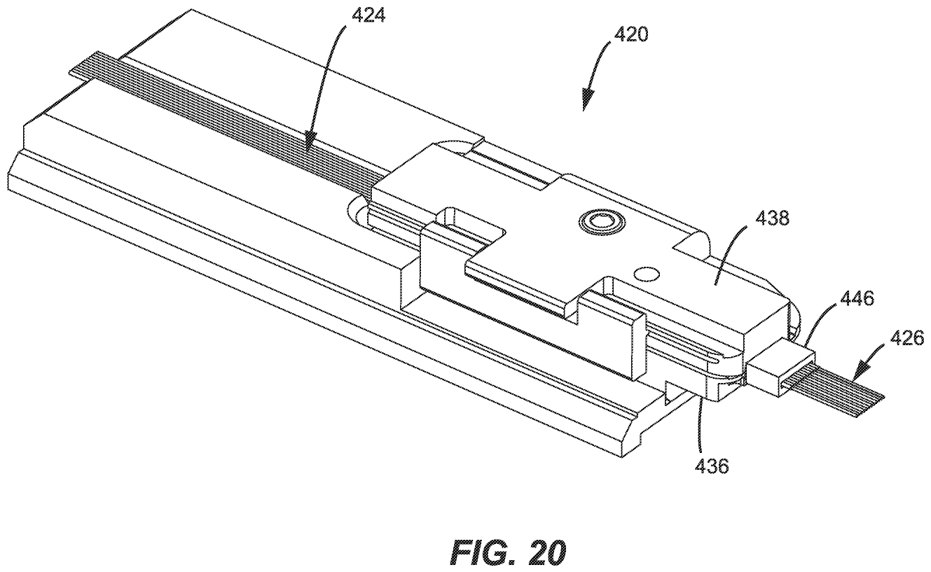

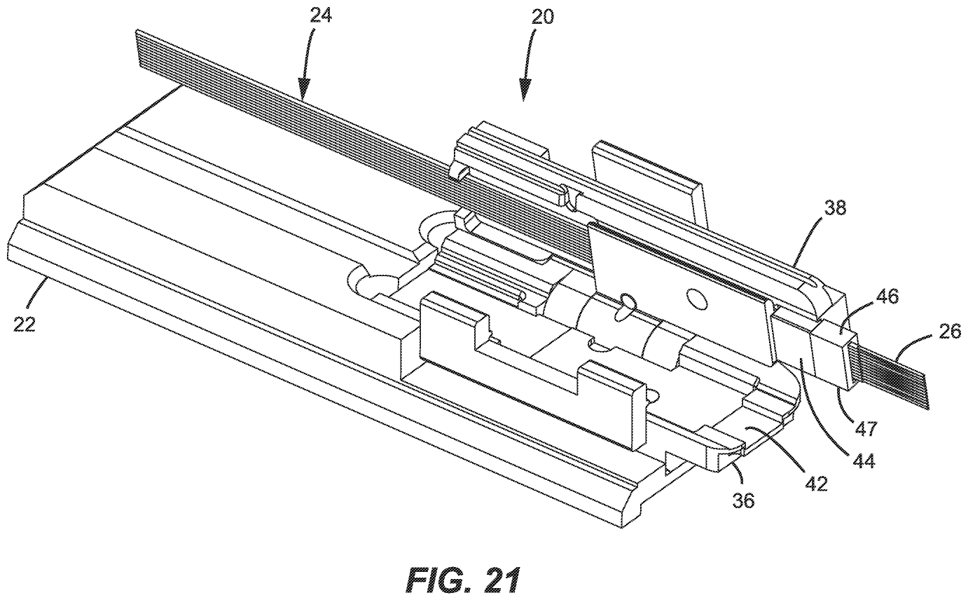

Referring to FIG. 19, the fiber holding clip 420 has a length L2 that extends between the front end 428 and a rear end 434 of the fiber holding clip 420. The fiber holding clip 420 includes a base 436 and a cover 438 that each extend from the front end 428 to the rear end 434. The fiber holding clip 420 includes a fiber passage 440 adapted for receiving the plurality of optical fibers 424 arranged in a row. The fiber passage 440 is located between the cover 438 and the base 436 and extends along the length L2 between the front and rear ends 428, 434. The fiber holding clip 420 defines a ferrule boot receptacle 442 at the front end 428. As shown at FIGS. 20 and 21, the ferrule boot receptacle 442 is sized to receive a rear end portion 444 of a multi-fiber ferrule boot 446. The multi-fiber ferrule boot 446 defines a through-passage for receiving the end portions 426 of the optical fibers 424. The through-passage preferably has an elongate transverse cross-sectional shape.

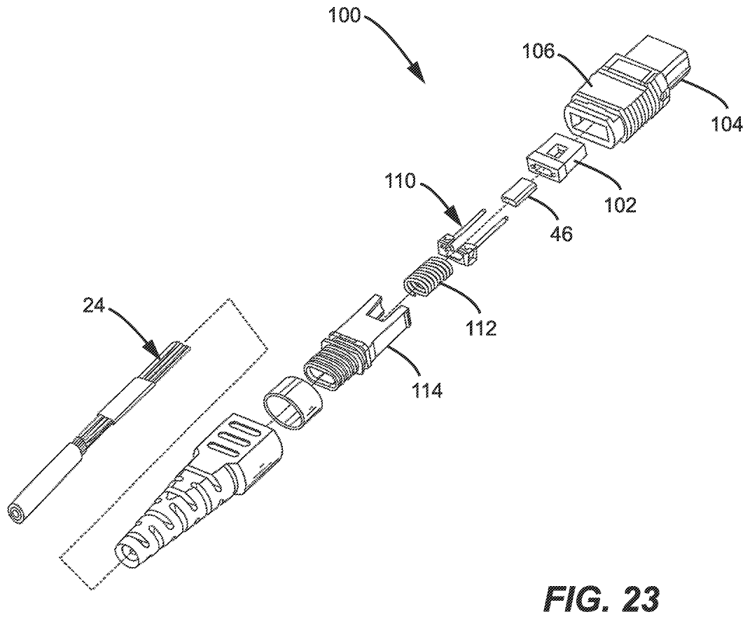

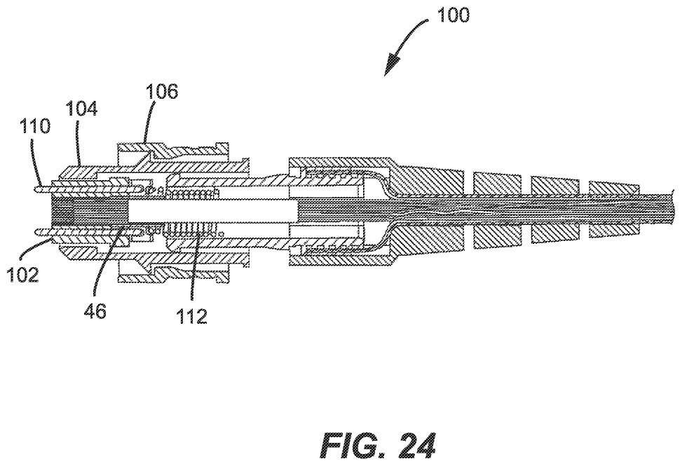

It will be appreciated that the multi-fiber ferrule boot 446 is adapted to be mounted within the rear end of a multi-fiber ferrule. In certain examples, multi-fiber ferrule boots are used to assist in containing adhesive such as epoxy within the multi-fiber ferrule. Referring to FIGS. 23 and 24, an example fiber optic connector 500 (e.g., an MPO connector) having a multi-fiber ferrule 502 is depicted. The fiber optic connector 500 includes a connector body 504 on which a release sleeve 506 is mounted. A ferrule assembly mounts within the connector body 504. The ferrule assembly includes the multi-fiber ferrule 502, the ferrule boot 516, an alignment pin assembly 510, and a spring 512. The ferrule assembly is retained within the connector body 504 by a rear connector body 514. When assembled, the spring 512 biases the ferrule 502 in a forward direction relative to the connector body 504.

FIG. 24 depicts the fiber optic connector 500 of FIG. 23 assembled. As depicted at FIG. 24, optical fibers 515 extend through the ferrule boot 508 and through the ferrule 502. The ferrule boot 508 is mounted within a rear portion of the ferrule 502. In certain examples, the ferrule boot 508 assists in containing epoxy within the ferrule 502. It will be appreciated that the epoxy can be injected or otherwise provided within the ferrule 502 for securing the optical fibers 515 within the ferrule 502.

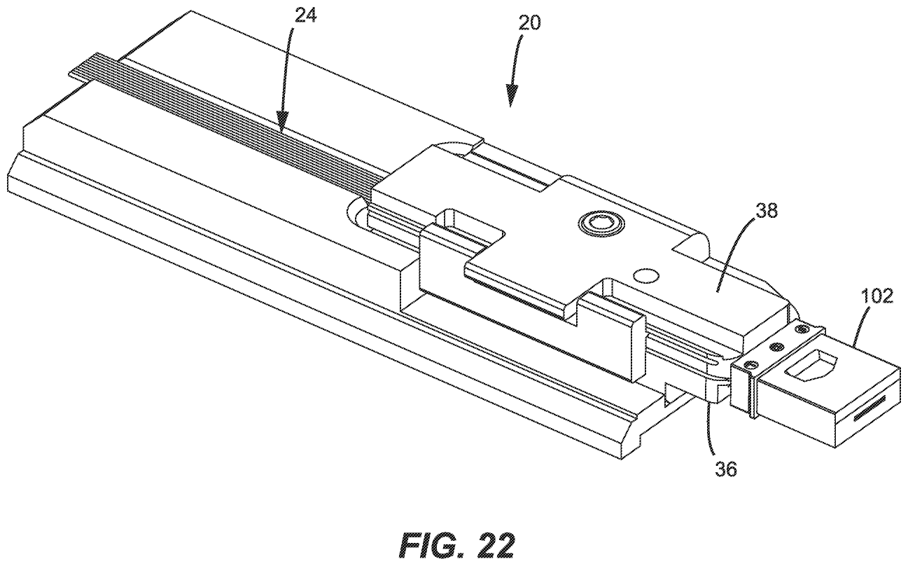

In a preferred example, the base 436 and the cover 438 of the fiber holding clip 420 are pivotally connected together and are pivotally movable relative to one another between an open position (see FIGS. 19 and 21) and a closed position (see FIGS. 20 and 22). The base 436 and the cover 438 are pivotally movable relative to one another about a pivot axis 514. It will be appreciated that the fiber holding clip 420 can be moved to the open position to allow the optical fibers 424 to be loaded into the fiber passage 440. After the fibers 424 have been loaded into the fiber holding clip 420, the base 436 and the cover 438 can be pivoted to the closed position.

As indicated above, the fiber holding clip 420 defines the ferrule boot receptacle 442 adapted for receiving the rear end portion 444 of a multi-fiber ferrule boot 446. FIG. 21 shows the clip 420 in the open position while the ferrule boot 446 is shown having been inserted over the optical fibers 424. FIG. 20 shows the clip 420 in the closed position with the rear end portion 444 of the ferrule boot 446 contained within the ferrule boot receptacle 442 at the front end 428 of the clip 420. As so positioned, the end portions 426 of the optical fibers 424 extend through the ferrule boot 446, the rear end portion 444 of the ferrule boot 446 is positioned within the ferrule boot receptacle 442, and a front portion 447 of the ferrule boot 446 projects forwardly from the front end 428 of the clip 420. In certain examples, the rear end portion 444 can be frictionally retained or clamped within the ferrule boot receptacle 442. The ferrule boot receptacle 442 can be defined in part by the base 436 and in part by the cover 438 such that the base 436 and the cover 438 cooperate to define the ferrule boot receptacle 442. In certain examples, the ferrule boot 446 can be inserted over the end portions 426 of the optical fibers 424 while the clip 420 is in the closed position and the rear end portion 444 can be inserted into the ferrule boot receptacle 442 while the clip 420 is in the closed position.

Referring back to FIG. 19, the fiber holding clip 420 further includes a fiber holding member 516 connected to and carried with the cover 438. The fiber holding member 516 and the cover 438 cooperate to define a fiber alignment portion 518 including a slot for aligning at least twelve of the optical fibers 424 in a row. It will be appreciated that the fiber holding member 516 is carried with the cover 438 as the cover 438 and the base 436 are moved between the open and closed positions. The slot is defined between the fiber holding member 516 and an inner side of the cover 438. The base 436 defines a recess 519 configured to receive the fiber holding member 516 when the clip 420 is moved to the closed position.

In certain examples, the fiber holding member 516 attaches to the cover 438 by a set screw 520. The spacing between the fiber holding member 516 and the cover 38 can be adjusted by the set screw 520 to set a size of the fiber alignment slot to correspond to a diameter of the coated portions of the optical fibers 424. Thus, in a preferred example, coated portions of the optical fibers 424 are received within the slot defined by the fiber holding member 516 and the cover 438. In certain examples, the optical fibers can be frictionally retained within the slot between the fiber holding member 516 and the cover 438.

In certain examples, the set screw 520 also attaches the fiber holding member 516 and the cover 438 to a pivot member 522 that pivotally couples the fiber holding member 516 and the cover 438 to the base 436. The pivot member 522 allows the cover 438 and the fiber holding member 516 to be pivoted together relative to the base 36 between the open and closed positions about the pivot axis 514.

It will be appreciated that the optical fibers 524 are loaded into the fiber holding region defined between the fiber holding member 516 and the cover 438 while the clip 420 is in the open position of FIG. 19. Preferably, the optical fibers 424 are loaded into the fiber holding region with the end portions 428 projecting forwardly beyond the front end 428 of the clip 420. Thus, the end portions 426 can readily be presented for processing when the clip 420 is loaded into a piece of equipment at a processing station. In certain examples, a latch can be provided for retaining the cover 438 and the base 436 in the closed position. In other examples, the base 436 and the cover 438 can be magnetically retained in the closed position.

FIGS. 19, 20, and 22 depict a process for assembling various components of a multi-fiber connector. For example, FIG. 19 shows the optical fibers 424 being loaded into the fiber holding region of the clip 420 such that the optical fibers 424 are arranged in a parallel row with the end portions 426 projecting forwardly from the front end 428 of the clip 420. Once the optical fibers 424 have been loaded into the clip 420, the clip 420 can be closed and the clip 420 while holding the optical fibers 424 can be moved to a ferrule boot insertion station. At the ferrule boot insertion station, the ferrule boot 446 can be inserted over the end portions 429 of the optical fibers 424 (see FIG. 20). As part of the insertion process, the rear portion 444 of the ferrule boot 446 can be inserted into the ferrule boot receptacle 442 defined by the front end 424 of the clip 420. It will be appreciated that the ferrule boot 446 can be frictionally retained within the ferrule boot receptacle 442. Once the ferrule boot 446 has been inserted over the end portions 426 of the optical fibers 424 and secured within the ferrule boot receptacle 442, the clip 420 can be moved to a ferrule insertion station where the multi-fiber ferrule 502 is inserted over the portions 426 of the optical fibers 424 and over the front end portion of the ferrule boot 46 (see FIG. 22). Preferably, the end portions 426 of the optical fibers are received within individual passages defined within the multi-fiber ferrule 502. Concurrent with the insertion of the optical fibers 424 into the passages of the multi-fiber ferrule 502, the front portion 447 of the ferrule boot 446 is received within a rear opening of the ferrule 502. Thereafter, epoxy can be injected into the ferrule 502 to retain the optical fibers 424 within their corresponding passages. It will be appreciated that the ferrule boot 446 can assist in providing containment of the epoxy within the ferrule 502 until the epoxy cures. In certain examples, the optical fibers 424 can be cleaved at a cleaving station. Cleaving can occur prior to insertion of the multi-fiber ferrule over the optical fibers 424, or after insertion of the ferrule over the optical fibers. Cleaving and/or stripping of the optical fibers can occur before or after insertion of the ferrule boot over the optical fibers.

From the forgoing detailed description, it will be evident that modifications and variations can be made without departing from the spirit and scope of the disclosure.

1. A process for manufacturing an optical fiber and ferrule assembly, the optical fiber and ferrule assembly including a row of optical fibers secured within parallel fiber passages of a ferrule, the fiber passages extending in a rear-to-front orientation through the ferrule, the fiber passages each having a front end at a front face of the ferrule, the process comprising:
securing the optical fibers in a clip;
establishing a first reference location relative to the optical fibers on the clip, the first reference location being an edge of the clip;
cleaving the optical fibers such that a first length along the optical fibers is defined between the first reference location and cleaved ends of the optical fibers;
inserting the ferrule over the optical fibers at a ferrule installation station, the ferrule installation station including a clip nest adapted for receiving the clip and a ferrule nest adapted for receiving the ferrule, the ferrule nest being integrated in a carrier that is linearly slidable relative to the clip nest between a retracted position and an extended position, the clip nest including a second reference location that contacts the first reference location when the clip is positioned in the clip nest, the second reference location being positioned a second length from a front face of the ferrule when the ferrule is in the ferrule nest and the carrier is in the retracted position, the second length being equal to the first length minus a third length, the third length being equal to a desired fiber projection distance beyond the front face of the ferrule, wherein the carrier moves toward the clip nest as the carrier is moved from the extended position toward the retracted position, wherein the clip is adapted to be positioned in the clip nest with free ends of the optical fibers extending toward the carrier, wherein with the ferrule positioned in the ferrule nest and the carrier in the extended position, the carrier is slid linearly toward the clip nest to cause the ferrule to be inserted over the free ends of the optical fibers, and wherein the optical fibers project the desired fiber projection distance beyond the front face of the ferrule when the carrier reaches the retracted position;
axially securing the optical fibers in the ferrule with the optical fibers positioned such that the cleaved ends of the optical fibers are spaced the desired fiber projection distance in front of the front face of the ferrule.

2. The process of claim 1, wherein the optical fiber is axially secured within the ferrule passage by adhesive that is cured after the cleaved end of the optical fiber has been positioned at the desired fiber projection distance in front of the front face of the ferrule.

3. The process of claim 1, wherein the cleaved end of the optical fiber is polished after the optical fiber is secured in the fiber passage.

4. The process of claim 1, wherein the optical fibers are cleaved by a mechanical cleaving process.

5. The process of claim 4, wherein cleaving takes place at a cleaving machine, wherein the cleaving machine includes a clip nest for receiving the clip during cleaving, wherein the clip nest includes the cleaver reference location, wherein the cleaver reference location is offset the first length from a cleaving location, and wherein the first reference location defined by the clip contacts the cleaver reference location when the clip is received within the clip nest such that when the optical fiber is cleaved the first length is defined along the optical fiber between the first reference location and the cleaved end of the optical fiber.

6. The process of claim 5, wherein a coating of the optical fiber is stripped prior to cleaving of the optical fiber, wherein stripping takes place at a stripping machine, wherein the stripping machine includes a clip nest for receiving the clip during stripping, wherein the clip nest of the stripping machine includes a stripping reference location, wherein the stripping reference location is offset a fourth length from a strip initiation location, wherein the fourth length is shorter than the first length, and wherein the first reference location defined by the clip contacts the stripping reference location when the clip is received within the clip nest of the stripping machine such that when the optical fiber is stripped the fourth length is defined along the optical fiber between the first reference location and the strip initiation location on the optical fiber.

7. The process of claim 5, wherein a plurality of different clip nest-defining inserts are individually mountable to the cleaving machine to alter the cleaver reference location and a magnitude of the first length.

8. The process of claim 6, wherein a plurality of different clip nest-defining inserts are individually mountable to the stripping machine to alter the stripping reference location and a magnitude of the fourth length.

9. The process of claim 6, wherein a ferrule boot is installed over the optical fibers before stripping of the optical fibers, wherein the ferrule boot is installed at a boot installation station including a clip nest and a boot nest, wherein the clip nest is adapted for receiving the clip and the boot nest is adapted for receiving the ferrule boot, wherein the boot nest is incorporated within a carrier that is linearly slidable relative to the clip nest, and wherein the clip is adapted to be positioned in the clip nest with free ends of the optical fibers extending toward the carrier, and wherein with the ferrule boot positioned in the boot nest, the carrier is slid linearly toward the clip nest to cause the ferrule boot to be inserted over the free ends of the optical fibers causing the ferrule boot to be installed over the optical fibers.

10.-15. (canceled)

16. An optical fiber holding device comprising:
a clip having a length that extends between a first end and a second end, the clip including a base and a cover that each extend between the first and second ends, the clip including a fiber passage that located between the cover and the base that extends between the first end and second ends, the clip defining a ferrule boot receptacle at the first end.

17. The optical fiber holding device of claim 16, wherein the base and the cover are pivotally connected together and are pivotally moveable relative to one another between an open position and a closed position about a pivot axis that extends along the length of the clip.

18. The optical fiber holding device of claim 16, wherein the base and the cover cooperate to define the ferrule boot receptacle.

19. The optical fiber holding device of claim 16, further comprising a fiber holding member carried with the cover, the fiber holding member and the cover cooperating to define a fiber alignment portion including a slot for aligning at least 12 optical fibers in a row.

20. The optical fiber holding device of claim 19, wherein the base defines a recess for receiving the fiber holding member when the clip is in the closed position.

21. The optical fiber holding device of claim 20, wherein the fiber holding member attaches to the cover by a set screw, and wherein a spacing between the fiber holding member and the cover can be adjusted by the set screw to set a size of the fiber alignment slot to correspond to a diameter of the coated optical fibers intended to be loaded therein.

22. The optical fiber holding device of claim 21, wherein the set screw also attaches the fiber holding member and the cover to a pivot member that pivotably couples the fiber holding member and the cover to the base, wherein pivot member allows the cover and the fiber holding member to be pivoted together relative to the base between the open and closed positions about pivot axis.

23. The optical fiber holding device of claim 16, wherein when the optical fibers are loaded into the clip, the optical fibers have end portions that project outwardly from the clip so as to be presented for processing when the clip is loaded into a piece of equipment.

24. The optical fiber holding device of claim 17, further comprising a latch for retaining the cover and the base in the closed position.
